(19) United States
(12) Patent Application Publication
(10) Pub. No.: US 2008/0207177 A1
(43) Pub. Date: Aug. 28, 2008

(54) METHOD AND APPARATUS PROVIDING VOICE MAIL SERVICE FOR HALF DUPLEX WIRELESS COMMUNICATION SYSTEMS

(76) Inventor: Kunal Shukla, Longmont, CO (US)

Correspondence Address: ERICSSON INC., 6300 LEGACY DRIVE, M/S EVR 1-C-11, PLANO, TX, 75024, US

(21) Appl. No.: 11/678,312

(22) Filed: Feb. 23, 2007

(51) Int. Cl. H04M 11/10

(52) U.S. Cl. 455/413

(57) ABSTRACT

A software and hardware implementation of a Half Duplex Voice Mail Server (HD-VMS), which provides subscription-based voice mail services for users in half duplex wireless networks. The user subscribes to the service and is provided with a voice mail box which records caller voice messages for the user when the user's handset is powered off or out of service, or when the user has enabled a privacy feature. The HD-VMS can be implemented in existing half duplex networks with minimal changes to the network. The implementation is technology independent and may be extended to host multiple half duplex communications technologies within the same network.

### CROSS-REFERENCE TO RELATED APPLICATIONS

NOT APPLICABLE

### STATEMENT REGARDING FEDERALLY SPONSORED RESEARCH OR DEVELOPMENT

NOT APPLICABLE

### REFERENCE TO SEQUENCE LISTING, A TABLE, OR A COMPUTER PROGRAM LISTING COMPACT DISC APPENDIX

NOT APPLICABLE

### BACKGROUND OF THE INVENTION

This invention relates to radio telecommunication systems. More particularly, and not by way of limitation, the invention is directed to a system and method for providing voice mail services for users with half duplex wireless service.

A half duplex communication system is a system that allows communication in both directions but only in one direction at a time. At any given time, only one user is transmitting (talking) and other users are receiving (listening). The services which are provided in the half duplex wireless systems are mainly 1-to-1 calls (individual calls), 1-to-Many calls (Group calls), and Call Alerts.

Current half duplex wireless communication systems provide a user with an indication that a half duplex call has been missed only when the user has his User Equipment (UE) powered on and in service. The system may notify the user of the missed call through a recent/missed call list, call alert queues, or other feature which is implemented on the UE handset. If the UE is powered off or out of service, there is no service in the half duplex wireless network that can provide information of missed half duplex calls during the time the UE is powered off or out of service.

There is no known solution to this problem. What is needed is a method and apparatus that overcomes the disadvantages of the prior art by providing voice mail services for users of half duplex wireless service while the user's UE is powered off or out of service. The present invention provides such a method and apparatus.

### BRIEF SUMMARY OF THE INVENTION

The present invention provides subscription-based voice mail services for users in half duplex wireless networks. The user subscribes to the service and is provided with a voice mail box which records caller voice messages for the user when the user's handset is powered off or out of service, or when the user has enabled a privacy feature.

Thus, in one aspect, the present invention is directed to a voice mail server for providing voice mail services in a half duplex wireless communication system. The server includes first input communication means for receiving a half duplex call routed to the server when a called user is unavailable; first output communication means for sending a notification to a calling user indicating that the called user is unavailable and inviting the calling user to leave a message; second input communication means for receiving the message from the calling user, and a voice mailbox for storing the message received from the calling user.

In another aspect, the present invention is directed to a system for providing voice mail services in a half duplex wireless communication network. The system includes a half duplex voice mail server; and a network interfacing unit for interfacing the wireless communication network with the half duplex voice mail server.

In another aspect, the present invention is directed to a method of providing voice mail services in a half duplex wireless communication network. The method includes the steps of interfacing a half duplex voice mail server with the wireless communication network; determining by the network that a called user is unavailable; notifying a calling user that a voice message can be recorded; setting up a connection between the calling user and the half duplex voice mail server; and storing the voice message in a voice mailbox in the half duplex voice mail server.

### BRIEF DESCRIPTION OF THE SEVERAL VIEWS OF THE DRAWING

In the following, the essential features of the invention will be described in detail by showing preferred embodiments, with reference to the attached figures in which:

FIG. 1 is a simplified block diagram of an exemplary embodiment of the Half Duplex Voice Mail Service (HD-VMS) system of the present invention;

FIG. 2 is a simplified block diagram illustrating the HD-VMS system in an exemplary integration into an HD wireless network;

FIG. 3 is a simplified block diagram of an exemplary embodiment of the present invention illustrating the flow of messages for routing a 1-to-1 individual call to voice mail in a half duplex network when the callee is unavailable;

FIGS. 4A and 4B are portions of a call flow diagram illustrating in more detail the flow of messages during the process illustrated in FIG. 3;

FIG. 5 is a simplified block diagram of an exemplary embodiment of the present invention illustrating the flow of messages for routing a 1-to-Many group call to voice mail in a half duplex network when one of multiple callees is unavailable;

FIGS. 6A and 6B are portions of a call flow diagram illustrating in more detail the flow of messages during the process illustrated in FIG. 5;

FIG. 7 is a simplified block diagram of an exemplary embodiment of the present invention illustrating the flow of messages for routing a 1-to-1 individual call to voice mail in a half duplex network when the callee has enabled a privacy feature;

FIG. 8 is a call flow diagram illustrating in more detail the flow of messages during the process illustrated in FIG. 7;

FIG. 9 is a simplified block diagram of an exemplary embodiment of the present invention illustrating the flow of messages for sending a voice mail notification in a half duplex network to a newly registered user;

FIG. 10 is a call flow diagram illustrating the flow of messages for sending a voice mail notification in a half duplex network to a registered user who has been unavailable;

FIG. 11 is a simplified block diagram of an exemplary embodiment of the present invention illustrating the flow of messages for retrieving a voice mail message by a user in a half duplex network;

FIG. 12 is a call flow diagram illustrating in more detail the flow of messages during the process illustrated in FIG. 11; and

FIG. 13 is a simplified block diagram of an exemplary embodiment of the present invention when implemented in a server bridging two different wireless networks.

### DETAILED DESCRIPTION OF THE INVENTION

The present invention is preferably a software and hardware implementation of a Half Duplex Voice Mail Server (HD-VMS), which provides subscription-based voice mail services for users in half duplex wireless networks. The user subscribes to the service and is provided with a voice mail box which records caller voice messages for the user when the user's handset is powered off or out of service, or when the user has enabled a privacy feature. The HD-VMS can be implemented in existing half duplex networks with minimal changes to the network. The implementation is technology independent and may be extended to host multiple half duplex communications technologies within the same network.

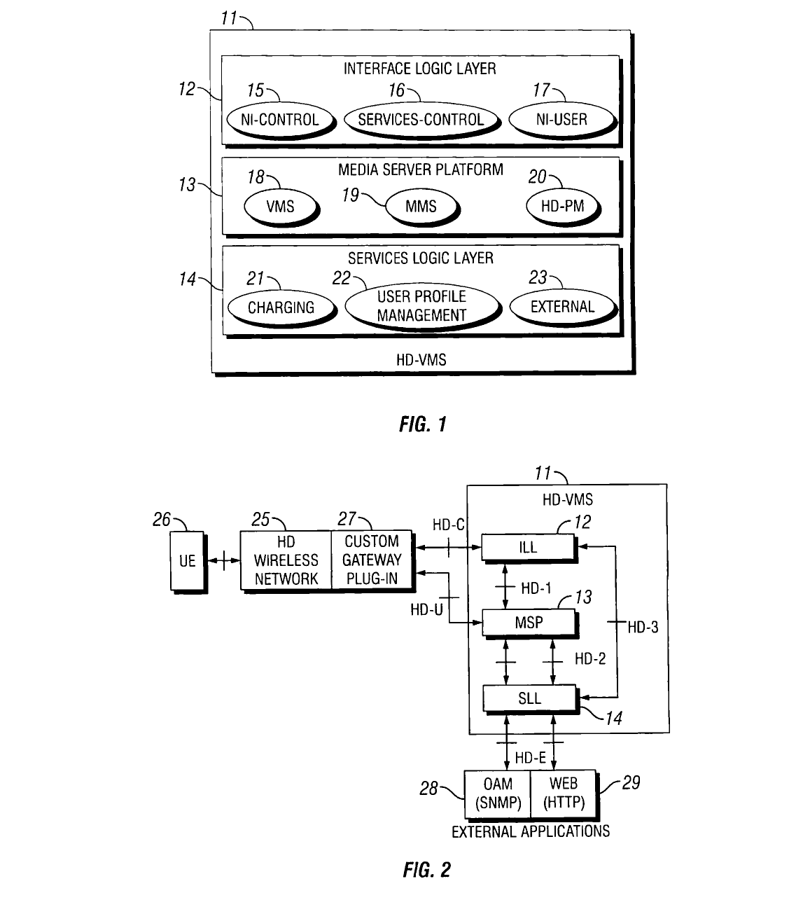

FIG. 1 is a simplified block diagram of an exemplary embodiment of the HD-VMS 11 of the present invention. The architecture of the HD-VMS is open and modular. The architecture is distributed over three layers, namely an Interface Logic Layer (ILL) 12, a Media Server Platform (MSP) 13, and a Services Logic Layer (SLL) 14. The ILL is the bridging layer which facilitates the integration of the HD-VMS to the existing half duplex wireless communication network. The ILL has entities which are used to host the control and the user plane data from the existing networks. Functionally, the ILL includes an NI-Control unit 15, a Services-Control unit 16, and a NI-User unit 17. The NI-Control unit 15 establishes the control plane between the network gateway and the HD-VMS. The NI-Control unit requests the allocation and release of required resources on the MSP 13. The Services-Control unit 16 interfaces the control plane between the HD-VMS and the SLL 14, which may interact with external applications for other services. The NI-User unit 17 sets up the user plane for the media to flow from the external existing network to the HD-VMS MSP 13.

The MSP 13 includes a VMS 18, an MMS 19, and an HD-PM 20. The MSP is a hardware and software platform, which stores the media recorded when the called user is not available. The MSP is controlled by the ILL 12 for resource allocation/release and playback. The MSP can host multiple applications based on the support provided by the network. The VMS 18 stores voice mail recordings and indexes them based on the user ID (IMSI/Phone number). The MMS 19 stores multimedia messages and indexes them based on user ID (IMSI/Phone number). The HD-PM 20 stores pictures which can be sent and stored on the server.

The SLL 14 includes a Charging unit 21, a User Profile Management unit 22, and an External Interfaces unit 23 for interfacing with external entities such as an Operations and Maintenance (OAM) system and a Web interface. These functions can be either implemented at this layer, or adaptors can be created to interface with External applications. The SLL also interacts with the MSP 13 and ILL 12 directly in order to perform the required services directly on these layers. The Charging unit 21 provides an interface/function for the charging (i.e., billing) function. The User Profile Management unit 22 manages the user profile based on the service to which it has subscribed. For example a first user may subscribe to only voice messaging and no multimedia, while a second user may not subscribe to the service at all. The External Interfaces unit 23 provides external interfaces such as OAM or web interfaces for monitoring statistics and KPI of the system.

FIG. 2 is a simplified block diagram illustrating the HD-VMS system 11 in an exemplary integration into an HD wireless network 25. A User Equipment (UE) 26 interfaces with the HD wireless network using a known interface. The HD-VMS system interfaces with the HD wireless network through a new Gateway Plug-in 27. A newly defined external interface, the HD-c interface, provides an interface between the HD Wireless Network Gateway Plug-in and the ILL 12 of the HD-VMS. The HD-c interface is used to set up the control plane between the entities. Another newly defined external interface is the HD-u interface. The HD-u interface provides an interface between the Gateway Plug-in and the MSP 13 of the HD-VMS. The HD-u interface is used to set up the user plane between the entities in order to record the VMS, MMS, or HD-PM for the unavailable subscriber.

The HD-VMS 11 also includes a number of internal interfaces for signaling between the ILL 12, the MSP 13, and the SLL 14. The newly defined HD-1 interface provides an interface between the ILL and the MSP. The HD-1 interface is used to assign required media services and assign ports on which the HD Wireless Network Gateway Plug-in 27 may communicate with the MSP. An HD-2 interface provides an interface between the MSP and the SLL. An HD-3 interface provides an interface between the ILL and the SLL of the HD-VMS. The HD-3 interface is used for charging, user profile management, and other external application interaction purposes.

Finally, a newly defined external interface, the HD-e interface, provides an interface between the SLL 14 of the HD-VMS 11 and external entities such as an OAM system 28 or a Web interface 29.

The following messages are implemented for interaction between the network gateway (through gateway plug-in 27) and various layers of the HD-VMS 11.

1. ActVMSReq: This message is sent from the Gateway plug-in 27 to the ILL 12 indicating that it should Activate the resources for recording a VMS for “x” user.

Mandatory Information Elements:
Message Identifier
Sequence ID
Caller's ID
Callee's ID
Required resource type—media format.

2. ActVMSResp: This message is sent from the ILL 12 back to the gateway plug-in 27 indicating that the ActVMSReq message was received and resources were allocated at the MSP 13.

Mandatory Information Elements:
Message Identifier
Sequence ID
IP for the MSP
Resource media format
Port number on the MSP.

3. ActVMSRespAck: This message is sent from the gateway plug-in 27 to the ILL 12 acknowledging that the VMS is activated from “x” user.

Mandatory Information Elements:
Message Identifier
Sequence ID.

4. ResourceAssignReq: This message is sent from the ILL 12 to the MSP 13 requesting resources to store the media from the user.

Mandatory Information Elements:
Message Identifier
Sequence ID
Caller ID
Callee ID
Media format.

5. ResourceAssignResp: This message is sent from the MSP 13 to the ILL 12 acknowledging the ResourceAssignReq and confirming that media resources have been allocated on the MSP.

Mandatory Information Elements:
Message Identifier
Sequence ID
Resource ID (unique ID for each call instance at the MSP)
Media format
IP address of the MSP
Port number on the MSP.

6. DefaultMsgComplete: This message is sent from the MSP 13 to the ILL 12 indicating that the default playback message (user greeting) is completed and the resources can be released so that the user can leave a voice message.

Mandatory Information Elements:
Message Identifier
Sequence ID.

7. DefaultMsgCompleteAck: This message is sent to acknowledge the above message.

Mandatory Information Elements:
Message Identifier
Sequence ID

8. ResourceReleaseReq: This message is sent from the ILL 12 to the MSP 13 requesting to release the resources which were reserved for storing the voice message.

Mandatory Information Elements:
Message Identifier
Sequence ID
Resource ID.

9. ResourceReleaseResp: This message is sent from the MSP 13 to the ILL 12 confirming that the resources have been released.

Mandatory Information Elements:
Message Identifier
Sequence ID
Response Flag.

10. checkVMStatusReq: This message is sent from the Gateway plug-in 27 to the ILL 12 to check whether the registered user has a voice mail at the MSP 13.

Mandatory Information Elements:
Message Identifier
Sequence ID
user ID (IMSI).

11. checkVMStatusResp: This message is sent from the ILL 12 to the gateway plug-in 27 with information regarding whether the HD-VMS has a voice message for the user.

Mandatory Information Elements:
Message Identifier
Sequence ID
Response Flag.

12. RetrieveVMReq: This message is sent from the gateway plug-in 27 to the ILL 12 requesting to retrieve the voice message from the HD-VMS.

Mandatory Information Elements:
Message Identifier
Sequence ID
userID.

13. RetrieveVMResp: This message is sent from the ILL 12 to the gateway plug-in 27 confirming that resources have been assigned, and the voice message can be retrieved from the HD-VMS.

Mandatory Information Elements:
Message Identifier
Sequence ID
Response Flag.

14. FloorGCVMReqMsg: This message is sent from the gateway plug-in 27 to the ILL 12 indicating that the Floor is requested during a group call, and VM for one of the participants is active in that group call.

Mandatory Information Elements:
Message Identifier
Sequence ID
UserID
Resource ID (unique ID for each call instance for recording voice message).

15. FloorGCVMRespMsg: This message is sent from the ILL 12 to the gateway plug-in 27 indicating the resources status for the group call at the MSP 13.

Mandatory Information Elements:
Message Identifier
Sequence ID
Response Flag.

16. ChkResourceReq: This message is sent from the ILL 12 to the MSP 13 to check the status of the resources for media recording at the MSP.

Mandatory Information Elements:
Message Identifier
Sequence ID
Resource ID.

17. ChkResourceResp: This message is sent from the MSP 13 to the ILL 12 with the response on the resource status for group calls on the MSP.

Mandatory Information Elements:
Message Identifier
Sequence ID
Response Flag.

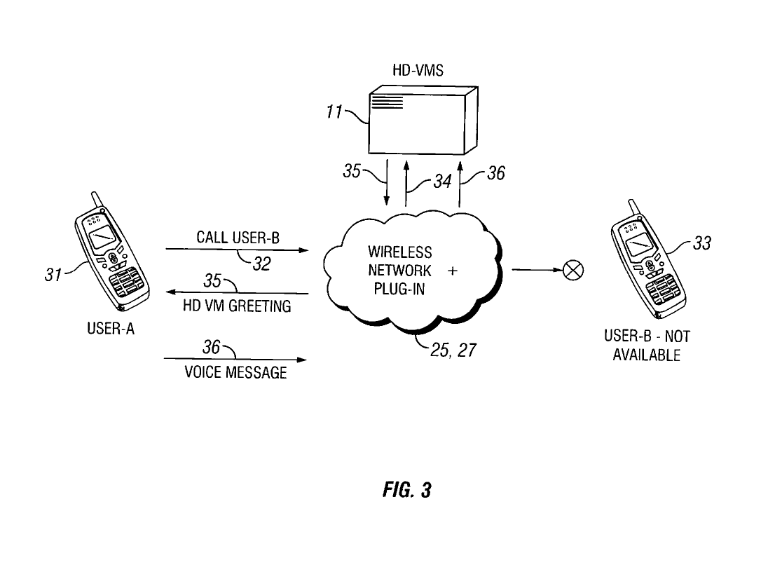

FIG. 3 is a simplified block diagram of an exemplary embodiment of the present invention illustrating the flow of messages for routing a 1-to-1 individual call to voice mail in a half duplex network when the callee is unavailable. User-A 31 sends a call setup request 32 to place a call to User-B 33 through the wireless network 25 and gateway plug-in 27. If User-B is not available, the network sends an Activate VMS Request 34 to the HD-VMS 11. The HD-VMS generates a pre-recorded greeting message 35, which is forwarded by the wireless network to User-A. Upon hearing the greeting message, User-A the caller may respond with a voice message 36, which is recorded at the HD-VMS.

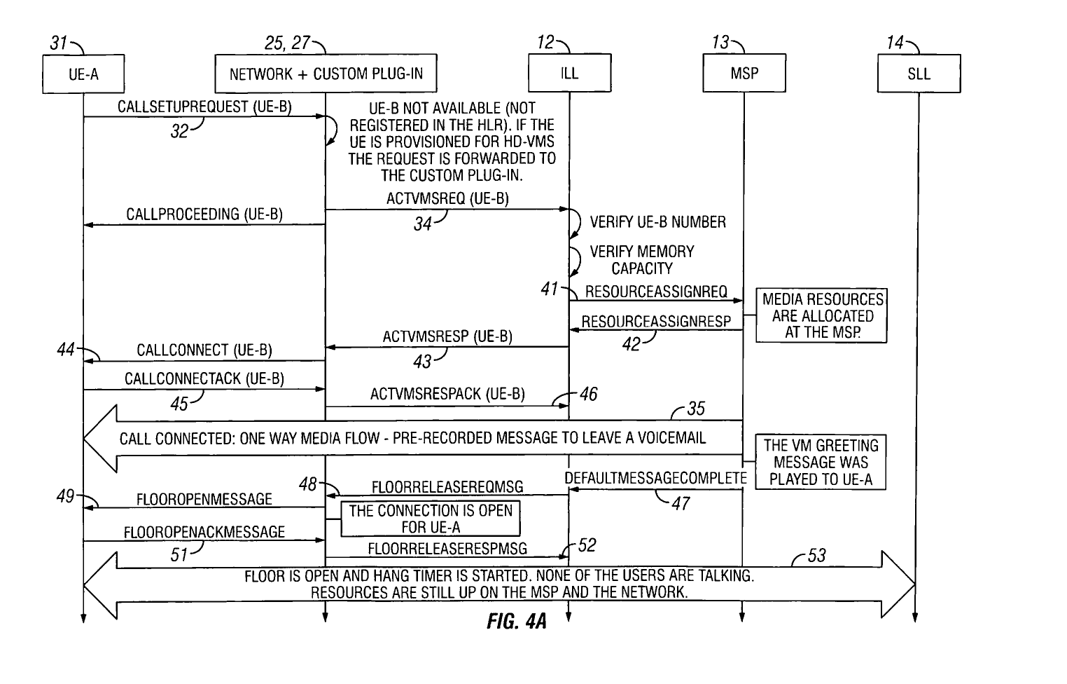

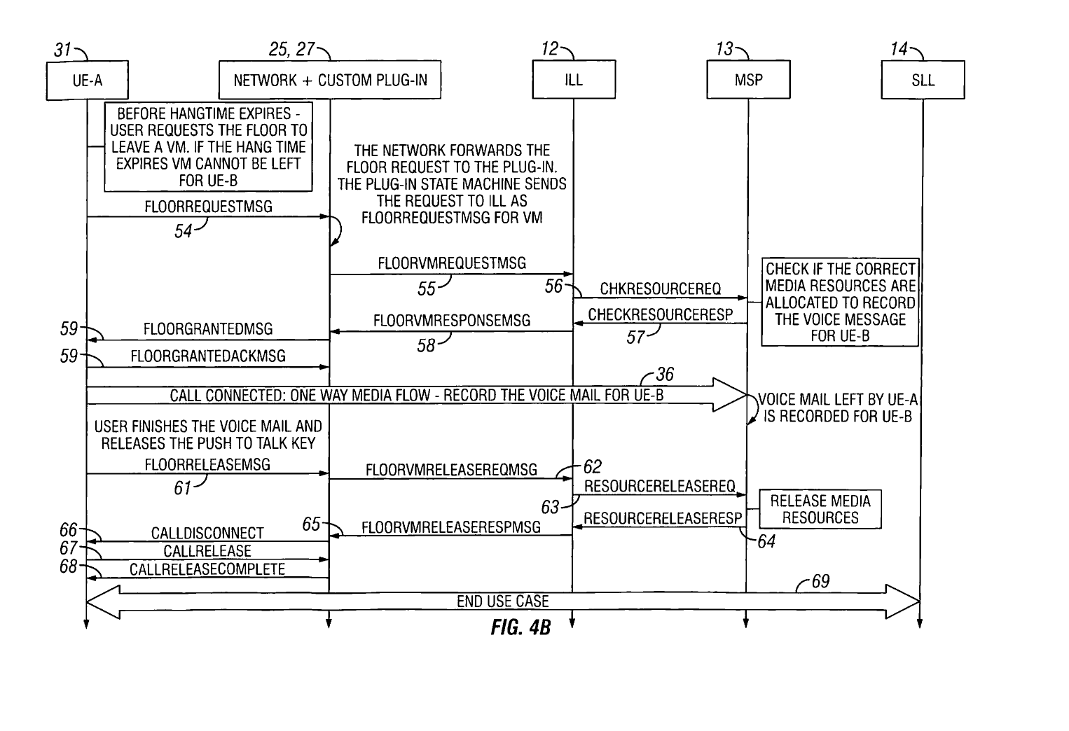

FIGS. 4A and 4B are portions of a call flow diagram illustrating in more detail the flow of messages during the process illustrated in FIG. 3. When UE-A 31 sends the call setup request 32 to place the call to User-B 33, the wireless network 25 determines that User-B is not available. For example, the UE-B may not be registered in the applicable Home Location Register (HLR) in the wireless network 25. If the UE-B is provisioned for HD-VMS, the request is forwarded to the custom gateway plug-in 27. The network then sends the Activate VMS Request 34 through the gateway plug-in 27 to the HD-VMS 11. In particular, the request is received by the ILL layer 12, which verifies the called UE-B number, verifies that memory space is available, and sends a Resource Assignment Request 41 to the MSP 12. The MSP returns a Resource Assignment Response 42 to the ILL, which sends an Activate VMS Response 43 to the wireless network via the gateway plug-in. The wireless network then sends a Call Connect message 44 to UE-A 31, which returns a Call Connect Acknowledgment message 45. The wireless network then sends an Activate VMS Response Acknowledgment message 46 through the gateway plug-in to the ILL. The MSP then generates the pre-recorded greeting message 35, which is forwarded by the wireless network and played to UE-A.

The MSP 13 then sends a Default Message Complete message 47 to the ILL 12 in the HD-VMS 11. The ILL 12 sends a Floor Release message 48 to the wireless network 25, which sends a Floor Open message 49 to UE-A 31. UE-A sends a Floor Open Acknowledgment message 51 to the wireless network 25 and gateway plug-in 27, which sends a Floor Release Response message 52 to the ILL. At 53, the floor is open, and a hang timer is started. Note that none of the users are talking at this point; the resources are still up on the MSP 13 and the network.

The process then moves to FIG. 4B, where the User-A 31 sends a Floor Request message 54 to the network 25 before the hang timer expires, requesting the floor for leaving a voice message. The network forwards the Floor Request message to the gateway plug-in 27, which sends a Floor Voice Mail Request message 55 to the ILL 12. The ILL sends a Check Resource Request message 56 to the MSP 13, which determines whether the correct media resources are allocated for recording the voice message for UE-B. The MSP then returns a Check Resources Response message 57 to the ILL. The ILL then returns a Floor Voice Mail Response message 58 to the network, which sends a Floor Granted message 59. UE-A responds with a Floor Granted Acknowledgment message 60. The call is then connected between UE-A 31 and the HD-VMS 11, and UE-A sends the voice message 36, which is recorded by the MSP 13.

When User-A completes the message and releases the push-to-talk (PTT) key on UE-A, UE-A sends a Floor Release message 61 to the network 25. The network forwards the Floor Release message to the gateway plug-in 27, which sends a Floor Voice Mail Release Request message 62 to the ILL 12. The ILL sends a Resource Release Request message 63 to the MSP 13, which releases the media resources and returns a Resource Release Response message 64 to the ILL. The ILL then returns a Floor Voice Mail Release Response message 65 to the wireless network, which sends a Call Disconnect message 66 to UE-A. UE-A sends a Call Release message 67 to the network, which returns a Call Release Complete message 68 to UE-A. The process is completed at 69.

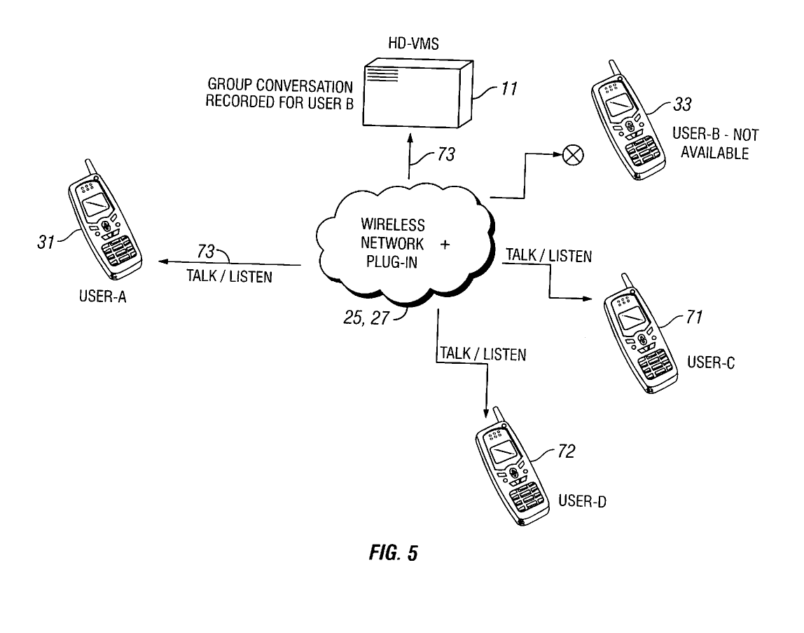

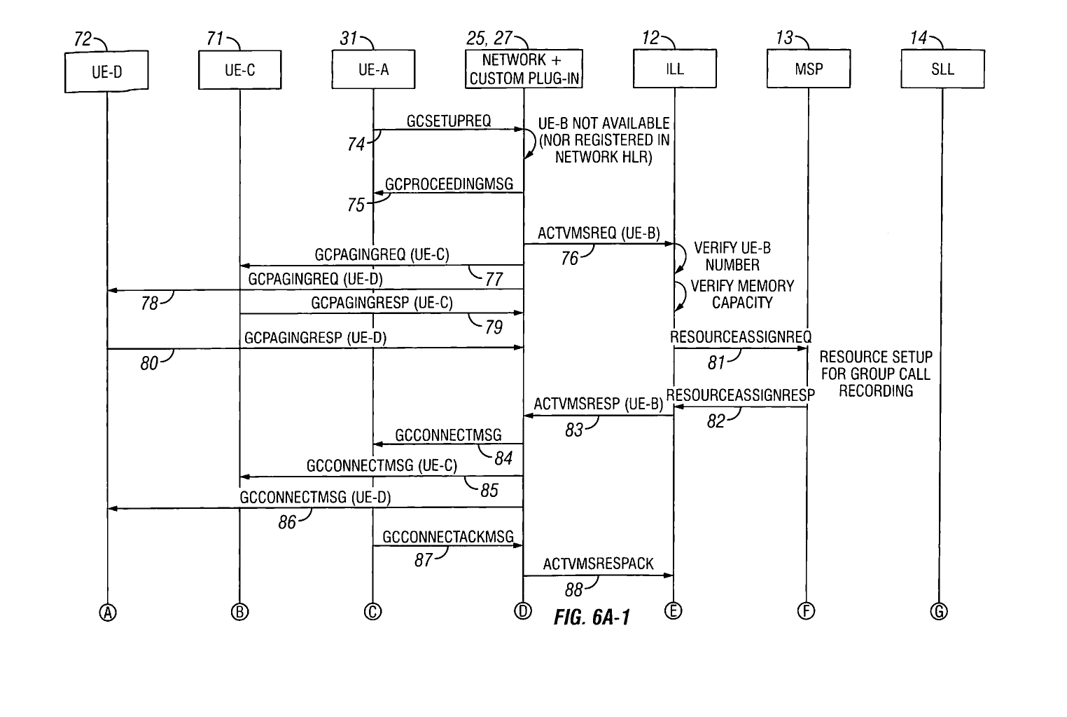

FIG. 5 is a simplified block diagram of an exemplary embodiment of the present invention illustrating the flow of messages for routing a 1-to-Many group call to voice mail in a half duplex network when one of multiple callees is unavailable. A group call has one caller and multiple callees. In the illustrated case, User-A 31 is calling User-B 33, User-C 71, and User-D 72. If one of the callees, such as User-B is not available, the network 25 routes User-A's voice packets 73 destined for User-B to the HD-VMS 11 via the gateway plug-in 27. When any other user in the group, such as User-D takes over as the caller, the voice packets from User-D are routed to the HD-VMS. The HD-VMS preferably records the group conversion between all the users. The voice mail service may be provided for ad hoc Group calls and Pre-Defined Group calls.

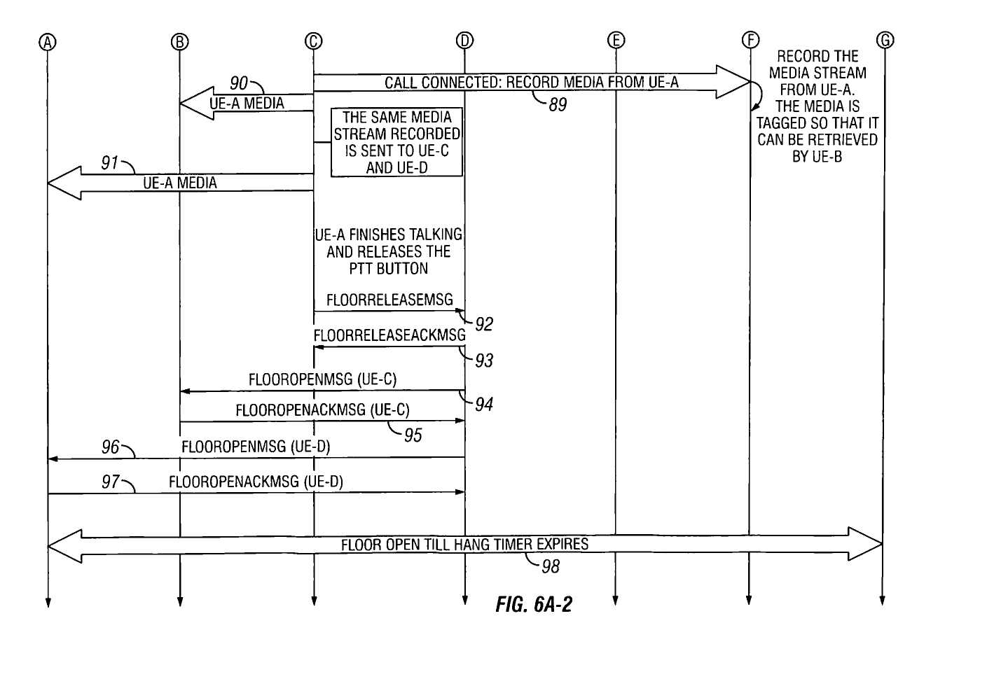

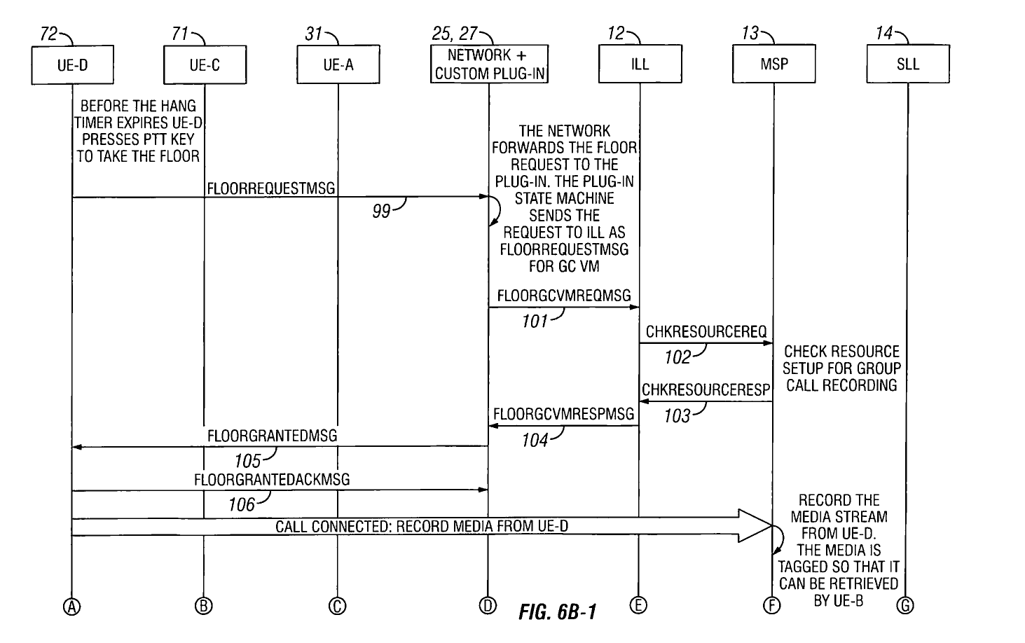

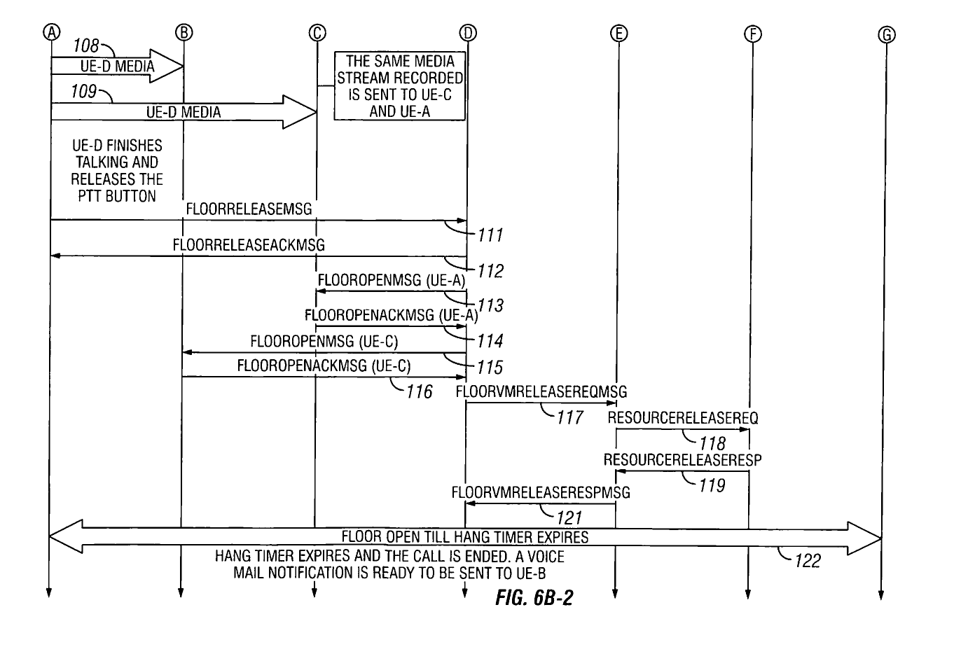

FIGS. 6A and 6B are portions of a call flow diagram illustrating in more detail the flow of messages during the process illustrated in FIG. 5. When UE-A 31 sends a Group Call Setup Request 74 to place the group call, the wireless network 25 determines that User-B 33 is not available. The network then sends a Group Call Proceeding message 75 to UE-A and sends an Activate VMS Request 76 through the gateway plug-in 27 to the ILL 12 in the HD-VMS 11. While the ILL verifies the called number and verifies that memory space is available, the network also sends a Group Call Paging Request to UE-C at 77 and to UE-D at 78. UE-C and UE-D send Paging Responses 79 and 80. The ILL 12 also sends a Resource Assignment Request 81 to the MSP 12. The MSP returns a Resource Assignment Response 82 to the ILL, which sends an Activate VMS Response message 83 to the wireless network via the gateway plug-in. The wireless network then sends Group Call Connect messages 84-86 to UE-A, UE-C, and UE-D. UE-A returns a Group Call Connect Acknowledgment message 87. The wireless network then sends an Activate VMS Response Acknowledgment message 88 through the gateway plug-in to the ILL. At 89, the MSP begins to record UE-A's voice packets 73 destined for UE-B. Concurrently, UE-A's voice packets (media stream) are sent to UE-C at 90 and UE-D at 91.

When User-A finishes talking, he releases the PTT button on UE-A 31. This causes UE-A to send a Floor Release message 92 to the network 25, which returns a Floor Release Acknowledgment message 93 to UE-A. The network then sends a Floor Open message 94 to UE-C 71, which returns an Acknowledgment 95. The network also sends a Floor Open message 96 to UE-D 72, which returns an Acknowledgment 97. network then sends Floor Open messages 94 and 95 to UE-C 71 and UE-D 72. UE-C and UE-D respond with Floor Open Acknowledgment messages 96 and 97. At 98, the floor remains open until the hang timer expires.

The process then moves to FIG. 6B where User-D pushes the PTT button on UE-D 72 to request the floor for leaving a voice message. UE-D sends a Floor Request message 99 to the wireless network 25, and the gateway plug-in 27 forwards a Floor Group Call Voice Mail Request message 101 to the ILL 12. The ILL sends a Check Resource Request message 102 to the MSP 13, which checks the resource setup for group call recording and returns a Check Resource Response message 103. The ILL then returns a Floor Group Call Voice Mail Response message 104 to the wireless network. The network sends a Floor Granted message 105 to UE-D, and UE-D responds with a Floor Granted Acknowledgment message 106. At 107, voice packets from UE-D are then recorded by the MSP 13 in the HD-VMS 11 while they are delivered to UE-C at 108 and UE-A at 109.

When User-D finishes talking, he releases the PTT button on UE-D 72. This causes UE-D to send a Floor Release message 111 to the network 25, which returns a Floor Release Acknowledgment message 112 to UE-D. The network then sends a Floor Open message 113 to UE-A 31, which returns an Acknowledgment 114. The network also sends a Floor Open message 115 to UE-C 71, which returns an Acknowledgment 116. The network then sends a Floor Voice Mail Release Request message 117 to the ILL 12. The ILL sends a Resource Release Request message 118 to the MSP 13. The MSP releases the resources and responds with a Resource Release Response message 119. The ILL then sends a Floor Voice Mail Release Response message 121 to the wireless network. At 122, the floor remains open until the hang timer expires. When the hang timer expires, the call is ended, and the HD-VMS 11 is ready to send a voice mail notification to UE-B 33.

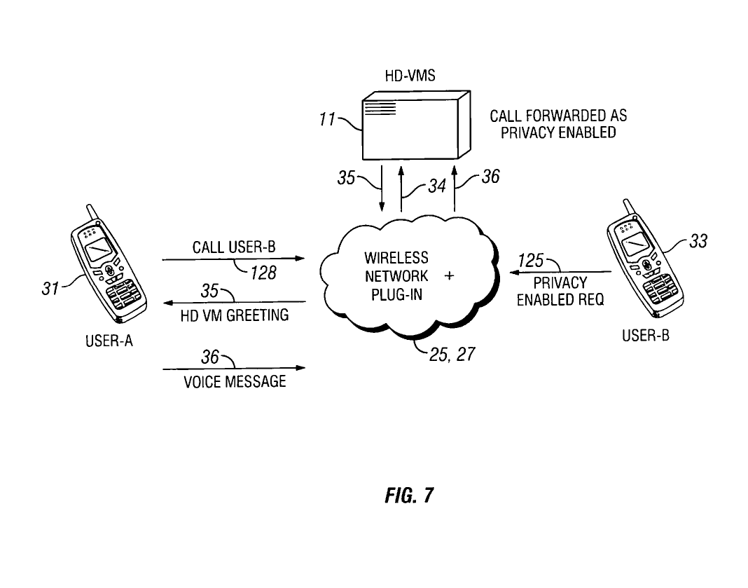

FIG. 7 is a simplified block diagram of an exemplary embodiment of the present invention illustrating the flow of messages for routing a 1-to-1 individual call to voice mail in a half duplex network when the callee has enabled a privacy feature utilized to provide privacy to the user. When User-B 33 sends a Privacy Enabled Request 125 to the network 25, the privacy feature is enabled on UE-B, and half duplex calls cannot be placed to User-B. Instead, the network routes all half duplex calls for User-B to the HD-VMS 11. The caller may leave a voice message for User-B who has the privacy feature enabled.

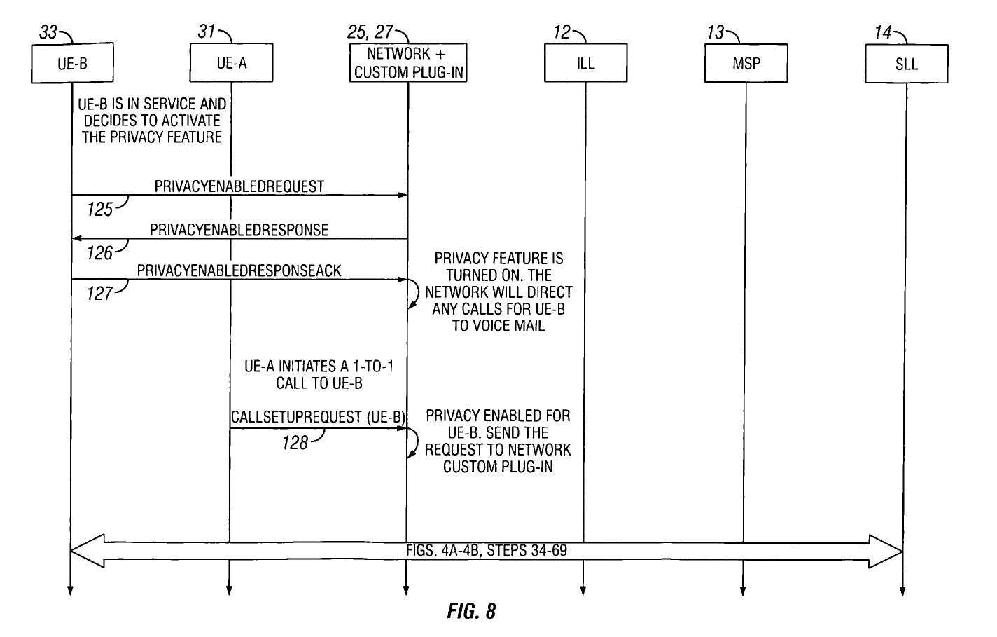

FIG. 8 is a call flow diagram illustrating in more detail the flow of messages during the process illustrated in FIG. 7. UE-B 33 sends the Privacy Enabled Request 125 to the wireless network 25, which returns a Privacy Enabled Response 126. UE-B then sends a Privacy Enabled Response Acknowledgment 127 to the network, which turns on the privacy feature, which will direct any future calls for UE-B to the HD-VMS 11. At a later time, UE-A 31 initiates a one-to-one call to UE-B by sending a Call Setup Request 128 to the network. The call is then routed to the HD-VMS in accordance with the procedures shown in FIGS. 4A-4B, steps 34-69.

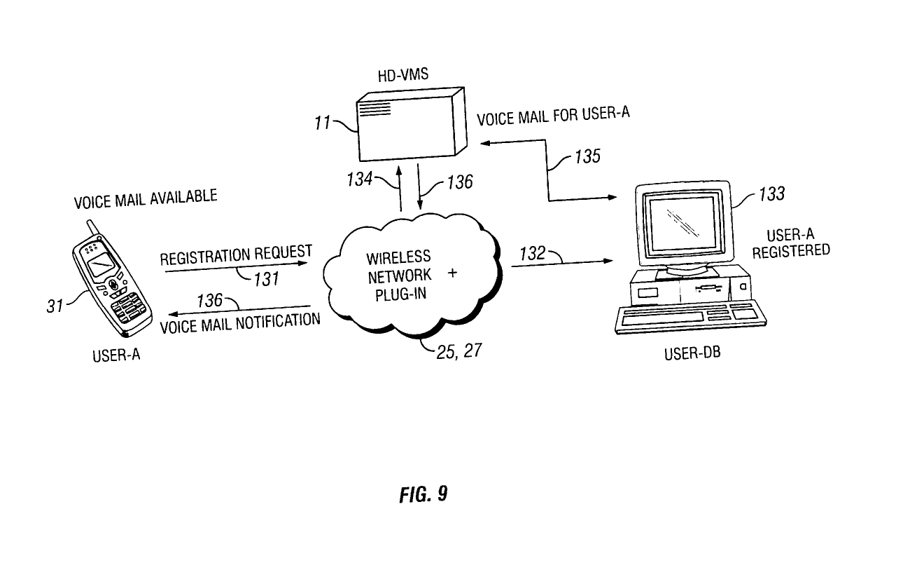

FIG. 9 is a simplified block diagram of an exemplary embodiment of the present invention illustrating the flow of messages for sending a voice mail notification in a half duplex network to a newly registered user. Whenever a voice message is stored in the HD-VMS 11 for a subscribing user, an HD-VM notification message is sent to the user when the user registers or otherwise becomes available. The user may become available, for example, by performing a power-on registration with the network, moving back into a coverage area, or disabling the privacy feature. The HD-VM notification may be in the form of an icon displayed on the user's handset or a call alert from the HD-VMS.

In the example depicted in FIG. 9, User-A 31 is initially not registered on the network. User-A then sends a Registration Request 131 to the wireless network 25. The network may send an update message 132 to a user registration database 133 such as an HLR to update the registration status of User-A. The HLR may update the gateway plug-in 27 regarding the registration of User-A, and the gateway plug-in then sends a query 134 to the ILL 12 of the HD-VMS 11 to determine if there are any stored voice mail messages for User-A. Alternatively, the HD-VMS 11 may directly interface with the HLR at 135 to determine User-A's registration status. The HD-VMS then checks for any stored messages for User-A, and if a voice message is present for User-A, an HD-VM notification 136 is sent to the subscriber.

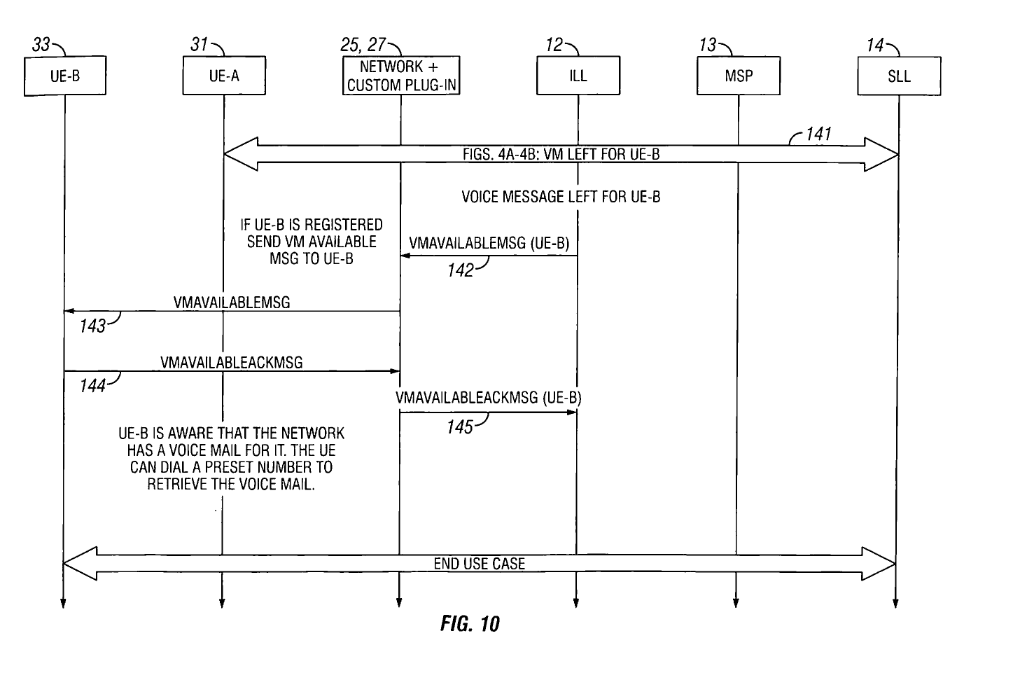

FIG. 10 is a call flow diagram illustrating the flow of messages for sending a voice mail notification in a half duplex network to a registered user who has been unavailable. For example, User-B 33 may have the privacy feature enabled. At 141, User-A 31 may leave a voice mail for User-B in accordance with the procedures shown in FIGS. 4A-4B. At a later time, User-B may disable the privacy feature. The ILL 12 then sends a Voice Mail Available message 142 to the network 25 through the gateway plug-in 27. The network forwards the Voice Mail Available message to UE-B at 143, and UE-B responds with a Voice Mail Available Acknowledgment message 144. At 145, the network forwards the Voice Mail Available Acknowledgment message to the ILL 12. UE-B is aware that the network has a voice mail for it, and the user can dial a predefined number to retrieve the voice mail from the HD-VMS 11.

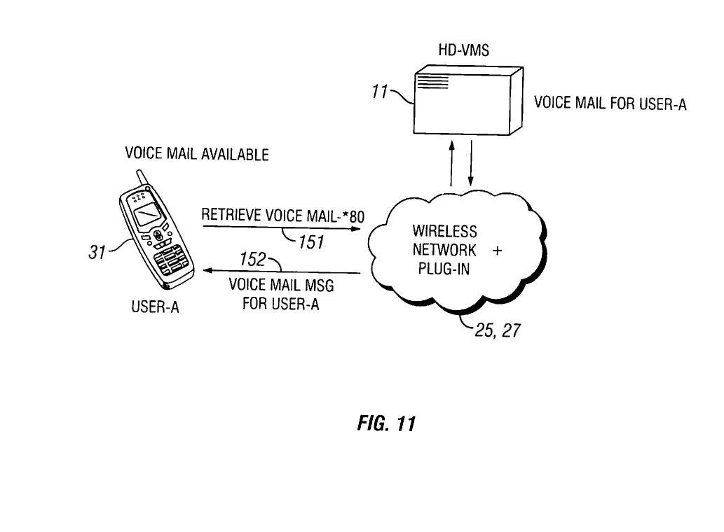

FIG. 11 is a simplified block diagram of an exemplary embodiment of the present invention illustrating the flow of messages for retrieving a voice mail message by a user in a half duplex network. At 151, after receiving an HD-VM notification, User-A 31 may dial a preset number such as, for example, “*80” to retrieve the voice mail from the HD-VMS 11. This preset number may be sent to the network 25 as a Call Setup Request directed to the HD-VMS. The HD-VMS in turn retrieves the HD-VM message and sends it to User-A at 152.

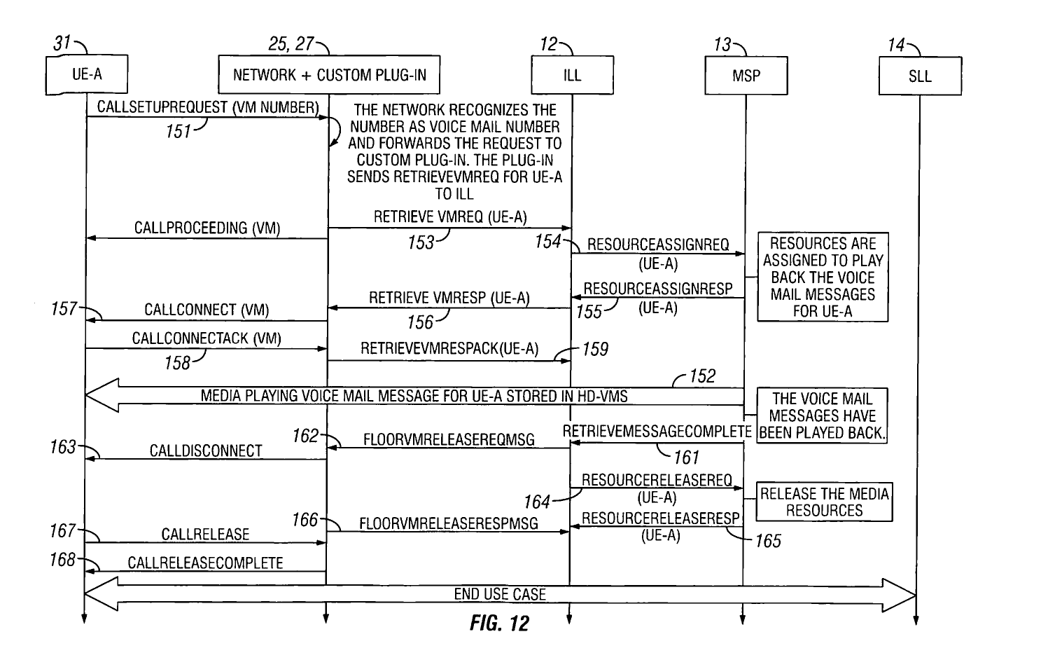

FIG. 12 is a call flow diagram illustrating in more detail the flow of messages during the process illustrated in FIG. 11. UE-A 31 sends a Call Setup Request 151 to the wireless network 25. The network recognizes the dialed number as a voice mail number and forwards the request to the gateway plug-in 27. The gateway plug-in sends a Retrieve Voice Mail Request message 153 to the ILL 12, identifying UE-A as the requesting party. The ILL sends a Resource Assign Request message 154 to the MSP 13, which assigns the resources to play back the voice mail messages for UE-A, and returns a Resource Assign Response message 155 to the ILL. The ILL sends a Retrieve Voice Mail Response message 156 to the network. The network sends a Call Connect message 157 to UE-A, indicating that the connection is being set up to the HD-VMS. UE-A sends a Call Connect Acknowledgment message 158 to the network, which sends a Retrieve Voice Mail Response Acknowledgment message 159 through the gateway plug-in to the ILL. At 152, the MSP 13 then plays any voice mail messages stored for UE-A.

Once the voice mail messages have been played, the MSP 13 sends a Retrieve Message Complete message 161 to the ILL 12. The ILL sends a Floor Voice Mail Release Request message 162 to the wireless network 25, and the network sends a Call Disconnect message 163 to UE-A 31. The ILL also sends a Resource Release Request message 164 to the MSP, which releases the media resources and returns a Resource Release Response message 165 to the ILL. The network also returns a Floor Voice Mail Release Response message 166 to the ILL. Finally UE-A sends a Call Release message 167 to the network, and the network returns a Call Release Complete message 168 to UE-A to end the procedure.

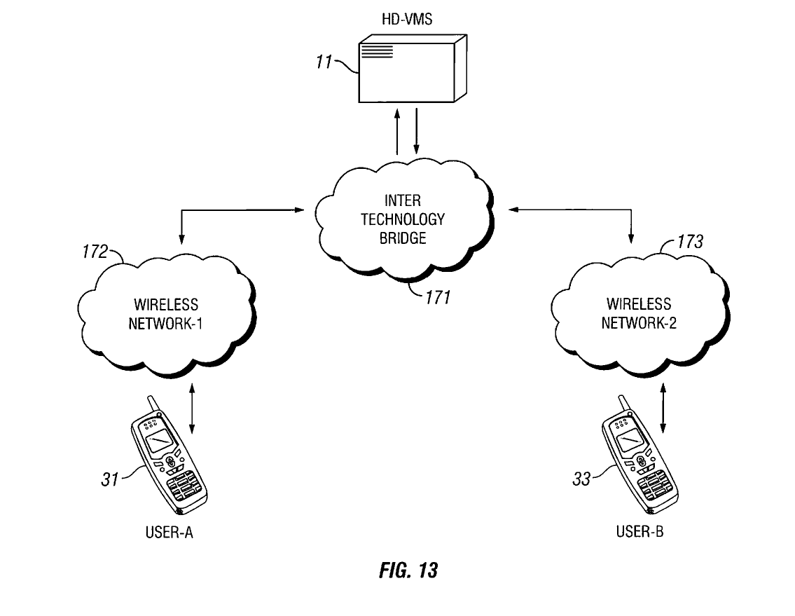

FIG. 13 is a simplified block diagram of an exemplary embodiment of the present invention when implemented in a server bridging two different wireless networks. The HD-VMS 11 may be implemented in a server providing an inter-technology bridge 171 between two networks of differing technologies such as wireless network-1 172 and wireless network-2 173. In this configuration, the HD-VMS performs the functions for voice mail recording for users in both networks during private and group calls (ad hoc and pre-defined).

Although preferred embodiments of the present invention have been illustrated in the accompanying drawings and described in the foregoing Detailed Description, it is understood that the invention is not limited to the embodiments disclosed, but is capable of numerous rearrangements, modifications, and substitutions without departing from the scope of the invention. The specification contemplates any all modifications that fall within the scope of the invention defined by the following claims.

What is claimed is:

1. A voice mail server for providing voice mail services in a half duplex wireless communication system, said server comprising:
first input communication means for receiving a half duplex call routed to the server when a called user is unavailable;
first output communication means for sending a notification to a calling user indicating that the called user is unavailable and inviting the calling user to leave a message;
second input communication means for receiving the message from the calling user; and
a voice mailbox for storing the message received from the calling user.

2. The voice mail server according to claim 1, further comprising:
third input communication means for receiving an indication that the called user has become available; and
second output communication means for sending a notification to the called user indicating that the called user has a message stored in the voice mailbox.

3. The voice mail server according to claim 2, further comprising:
fourth input communication means for receiving a request from the called user to retrieve the message; and
third output communication means for retrieving the message from the voice mailbox and sending the message to the called user.

4. The voice mail server according to claim 1, wherein the called user is one of a plurality of called users in a half duplex group call, and the first output communication means is adapted to notify the calling user of the identity of the unavailable called user.

5. The voice mail server according to claim 1, wherein the called user is one of a plurality of called users in a half duplex group call, and the second input communication means is adapted to receive and record the group call between all of the users.

6. The voice mail server according to claim 1, wherein the called user is one of a plurality of called users in a half duplex group call, and the server includes means for storing messages from multiple members of the group.

7. The voice mail server according to claim 1, wherein the half duplex voice mail server is implemented in a bridge between two different wireless networks, wherein the calling user is in a first wireless network and the called user is in a second wireless network.

8. A system for providing voice mail services in a half duplex wireless communication network, said system comprising:
a half duplex voice mail server; and
a network interfacing unit for interfacing the wireless communication network with the half duplex voice mail server.

9. The system according to claim 8, wherein the half duplex voice mail server includes an interface logic layer (ILL) and a media service platform (MSP), said ILL for hosting control plane and user plane data from the wireless communication network and for obtaining resource allocations from the MSP to support voice mail recording and playback.

10. The system according to claim 9, wherein the half duplex voice mail server also includes a services logic layer (SLL) for performing billing, user profile management, and interfacing the half duplex voice mail server with external entities.

11. A method of providing voice mail services in a half duplex wireless communication network, said method comprising:
interfacing a half duplex voice mail server with the wireless communication network,
determining by the network that a called user is unavailable;
notifying a calling user that a voice message can be recorded;
setting up a connection between the calling user and the half duplex voice mail server; and
storing the voice message in a voice mailbox in the half duplex voice mail server.

12. The method according to claim 11, further comprising:
determining by the network that the called user has become available; and
sending a notification to the called user indicating that the called user has a message stored in the voice mailbox.

13. The method according to claim 12, further comprising:
receiving a request from the called user to retrieve the message; and
retrieving the message from the voice mailbox and sending the message to the called user.

14. The method according to claim 11, wherein the called user is one of a plurality of called users in a half duplex group call, and the method further comprises notifying the calling user of the identity of the unavailable called user.

15. The method according to claim 11, wherein the called user is one of a plurality of called users in a half duplex group call, and the method includes receiving and recording the group call between all of the users.

16. The method according to claim 11, wherein the called user is one of a plurality of called users in a half duplex group call, and the method includes storing messages from multiple members of the group.

17. The method according to claim 11, wherein the half duplex voice mail server is implemented in a bridge between two different wireless networks, wherein the calling user is in a first wireless network and the called user is in a second wireless network.
